(19) United States
(12) Patent Application Publication
(10) Pub. No.: US 2026/0088608 A1
(43) Pub. Date: Mar. 26, 2026

(54) REDUNDANCY POWER GRID SYSTEM AND OPERATION METHOD THEREFOR

(71) Applicants: HYUNDAI MOTOR COMPANY, Seoul (KR); KIA CORPORATION, Seoul (KR)

(72) Inventor: Soon Chul Park, Hwaseong-si (KR)

(73) Assignees: HYUNDAI MOTOR COMPANY, Seoul (KR); KIA CORPORATION, Seoul (KR)

(21) Appl. No.: 19/083,886

(22) Filed: Mar. 19, 2025

(30) Foreign Application Priority Data
Sep. 24, 2024 (KR) 10-2024-0129164

(51) Int. Cl. H02H 7/22; H02J 3/00

(52) U.S. Cl. CPC H02H 7/22; H02J 3/0073

(57) ABSTRACT

A redundancy power grid system and an operation method therefor are disclosed. A redundancy power grid system includes a battery, a first controller including a main power fuse and a redundancy fuse, and multiple second controllers each including a first fuse and a second fuse. The first controller is connected with the battery. The second controllers are connected in series via a wire connected to the first fuse and a wire connected to the second fuse. The second controllers have two opposite end second controllers that are connected to the first controller via a wire connected with the main power fuse and a wire connected with the redundancy fuse, respectively.

### CROSS-REFERENCE TO RELATED APPLICATIONS

This application is based on, and claims priority to, Korean Patent Application Number 10-2024-0129164, filed Sep. 24, 2024, the disclosure of which is incorporated by reference herein in its entirety.

### TECHNICAL FIELD

The present disclosure relates to a redundancy power grid system and an operation method therefor. More particularly, the present disclosure relates to a redundancy power grid system that implements a redundancy circuit by wiring adjacent controllers and relates to an operation method for the redundancy power grid system.

### BACKGROUND

The statements in this section merely provide background information related to the present disclosure and do not necessarily constitute prior art.

A conventional power grid system with a plurality of controllers connected is composed of (1)) a system composed of multiple controllers directly connected to a battery, (2)) a system composed of a single controller directly connected to a battery, and multiple controllers powered by other controllers different than the single controller.

In a conventional power grid system, if any of the wires connecting the controllers have an anomaly, e.g., a disconnected wire or an overload, the controller powered through that wire may not operate normally.

### SUMMARY

In view of the above, an objective of the present disclosure is to provide a power grid system in which redundancy circuitry can be implemented to provide power through other wires if any wire fails. In particular, the power grid system may supply power to all controllers in any event, even if any wire fails, by implementing the redundancy circuitry through other wires.

The objectives to be achieved by the present disclosure are not limited to the above-mentioned objectives. Other objectives, which are not mentioned should be clearly understood by those of ordinary skill in the art from the following description.

According to at least one embodiment, the present disclosure provides a redundancy power grid system. The redundancy power grid system includes a battery, a first controller including a main power fuse and a redundancy fuse, and multiple second controllers each including a first fuse and a second fuse. The first controller is in connection with the battery. The second controllers are connected in series via a wire connected to the first fuse and a wire connected to the second fuse. The second controllers have two opposite-end second controllers that are connected to the first controller via a wire connected with the main power fuse and a wire connected with the redundancy fuse, respectively.

According to another embodiment, the present disclosure provides a method of operating a redundancy power grid system that includes a battery, a first controller including a main power fuse and a redundancy fuse, and multiple second controllers each including a first fuse and a second fuse. The first controller is connected with the battery. The second controllers are connected in series via a wire connected to the first fuse and a wire connected to the second fuse. The second controllers have two opposite-end second controllers that are connected to the first controller via a wire connected with the main power fuse and a wire connected with the redundancy fuse, respectively. The method includes causing the first controller to control on-off operations of the main power fuse and the redundancy fuse and causing the second controllers to control on-off operations of the first fuse and the second fuse.

According to one embodiment of the present disclosure, a redundant or redundancy circuitry may be implemented to provide power through other wires if any wire fails.

Effects of the present disclosure are not limited to the above-mentioned effects. Other effects that are not mentioned above should be clearly understood by those of ordinary skill in the art from the following description.

### BRIEF DESCRIPTION OF THE DRAWINGS

FIG. 1 is a schematic block diagram of a redundancy power grid system according to at least one embodiment of the present disclosure.

FIG. 2 is a schematic block diagram of a first controller according to at least one embodiment of the present disclosure.

FIG. 3 is a schematic block diagram of a second controller according to at least one embodiment of the present disclosure.

FIGS. 4A through 4C are diagrams illustrating the operation of a redundancy power grid system according to at least one embodiment of the present disclosure.

FIG. 5 is a flowchart of the operation of the first controller, according to at least one embodiment of the present disclosure.

FIG. 6 is a flowchart of a method of operating the second controller according to at least one of the present disclosure.

FIG. 7 is a schematic block diagram of an illustrative computing device that is applicable to the present disclosure.

### DETAILED DESCRIPTION

Hereinafter, various embodiments of the present disclosure are described in detail with reference to the accompanying drawings. In the following description, it should be noted that identical or equivalent elements or components are designated by identical reference numerals even when they are displayed in different drawings. Further, in the following description of various embodiments, a detailed description of known functions and configurations incorporated therein have been omitted for the purpose of clarity and for brevity.

Additionally, various terms such as first, second, A, B, (a), (b), and the like, are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

When a component, device, element, or the like of the present disclosure is described as having a purpose or performing an operation, function or the like, the component, device, or element should be considered herein as being “specifically configured to” meet that purpose or to perform that operation or function.

The following detailed description, together with the accompanying drawings, is intended to illustrate various embodiments of the present disclosure and is not intended to represent the only embodiments in which the disclosure may be practiced.

A controller may be implemented by one or more processors as described below. A first controller described below is a controller that is directly connected to a battery. A second controller is a controller that is not directly connected to a battery.

Hereinafter, a fault is a condition in which a wire of a redundancy power grid system does not operate normally, including a disconnected state and an overload condition. A disconnected state means a state in which the current flowing in the wire is equal to or smaller than a first threshold. An overload condition means a state in which the current flowing in the wire is equal to or greater than a second threshold.

Hereinafter, a main power fuse means a fuse connected with a wire for the first controller to supply power where all wires in the redundancy power grid system are normal.

Hereinafter, a redundancy fuse, which is different than the main power fuse, is connected to the wire for the first controller to supply power in the event of a fault in any wire of the redundancy power grid system.

Hereinafter, a first fuse is the fuse connected with a wire for the second controller to receive power where all wires in the redundancy power grid system are normal.

Hereinafter, a second fuse is the fuse connected with a wire for the second controller to supply power where all wires in the redundancy power grid system are normal. However, the second controller does not supply power when the second controller is connected to the first controller through the wire connected to the second fuse.

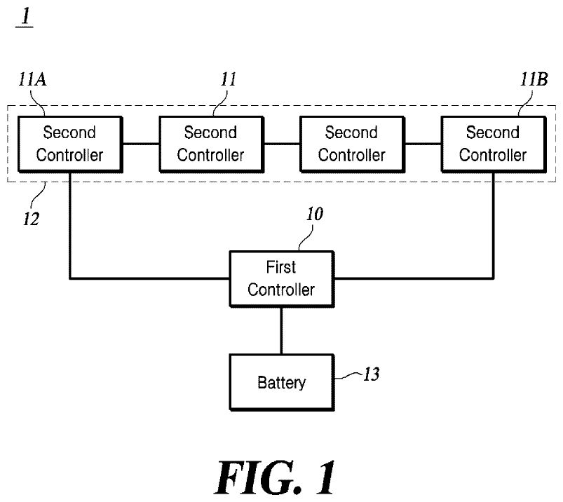

FIG. 1 is a schematic block diagram of a redundancy power grid system 1 according to at least one embodiment of the present disclosure.

The redundancy power grid system 1 includes at least one first controller 10, multiple second controllers 12, and a battery 13.

The first controller 10 is connected via a wire to the battery 13. The second controllers 12 are connected in series via wires. The second controllers 12 have, at two opposite ends thereof, second controllers 11A and 11B that are connected in series and are connected to the first controller 10 via wires.

The wires may transmit data and electric power. The first controller 10 receives power from the battery 13 via the wire. The first controller 10 may supply power via wires to the second controllers 11A and 11B connected to the first controller 10. After receiving power from the first controller 10, the second controllers 11A and 11B may supply power via the wires to other second controllers. The first controller 10 and the multiple second controllers 12 may communicate with each other via the wires.

The redundancy power grid system according to at least one embodiment of the present disclosure may be implemented by adding one or more wires connecting neighboring controllers, thereby enabling an economical implementation of a redundancy circuit.

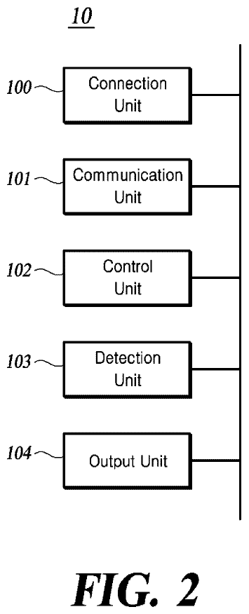

FIG. 2 is a schematic block diagram of the first controller 10 according to at least one embodiment of the present disclosure.

As shown in FIG. 2, the first controller 10 according to at least one embodiment of the present disclosure may include all or some of a connection unit 100, a communication unit 101, a control unit 102, a detection unit 103, and an output unit 104. Not all of the blocks illustrated in FIG. 2 are requisite components. In other embodiments, some of the blocks included in FIG. 2 may be added, changed, or deleted. Further, the components illustrated in FIG. 2 represent functionally classified elements, and at least one or more of the components may be implemented in a form that integrates in a real-world physical environment.

The connection unit 100 may have a plurality of wires connected to it. The connection unit 100 may be implemented by using a fuse. In one embodiment, the fuse includes an electronic fuse (e-fuse). The first controller 10 may be connected via a wire connected with the connection unit 100 to the battery. The first controller 10 may be connected via wires connected with the connection unit 100 to the other second controllers.

The communication unit 101 may communicate with the other controllers by using various communication techniques, including Controller Area Network (CAN) communication, e.g., ethernet, media oriented systems transport (MOST), Flexray, local interconnect network (LIN), and such automotive networks. The communication unit 101 may receive detection information from the other controllers. The communication unit 101 may transmit detection information to the other controllers. The detection information includes the magnitude of the current and a fault message. The fault message includes an ID of a fault detection controller or powering controller with a fault wire, an ID of a fault controller or powered controller with a fault wire, and fault information. The fault information includes whether the wire is disconnected and whether it is overloaded. The powering controller with a fault wire is the controller that supplies power through a faulted wire. The powered controller with a fault wire is a controller that receives power through the faulted wire.

The control unit 102 controls the operation of the connection unit 100 to control a path for supplying power to the second controller. The control unit 102 may control the path for supplying power to the second controller by controlling the on-off operation of the fuse.

When the detection unit 103 detects a fault in the wire connected with the main power fuse, the control unit 102 turns off the main power fuse and the control unit 102 turns on the first controller's redundancy fuse to supply power to the second controller by using the wire connected with the redundancy fuse.

If the main power fuse is turned on and the communication unit 101 receives a fault message from any one of the second controllers, the control unit 102 turns on the redundancy fuse to supply power to the second controllers by using the wires connected with the main power fuse and the redundancy fuse.

The detection unit 103 detects the condition of the wire connected to the connection unit 100 by detecting the magnitude of the current flowing in the wire. The detection unit 103 may determine whether a fault has occurred in the wire supplying power from the first controller 10 to the second controller by detecting the magnitude of the current. The detection unit 103 may determine that the wire connected with the main power fuse is in a disconnected state if the magnitude of the current flowing in the wire is equal to or smaller than the first threshold. The detection unit 103 may determine that the wire connected with the main power fuse is not disconnected if the magnitude of the current flowing in the wire is greater than the first threshold. The detection unit 103 may determine that the wire connected with the main power fuse is in an overload condition if the magnitude of the current flowing in the wire is greater than or equal to the second threshold. The detection unit 103 may determine that the wire connected with the main power fuse is not in an overload condition if the magnitude of the current flowing in the wire is less than the second threshold.

The output unit 104 provides the fault information to a user by using an output device. The output unit may be implemented as one of the various components of an electronic device, such as a display, smartphone, smartwatch, tablet, computer, ultra mobile PC (UMPC), workstation, net-book, personal digital assistant (PDA), portable computer, portable multimedia player (PMP), and audio system, but it is not limited to the foregoing examples.

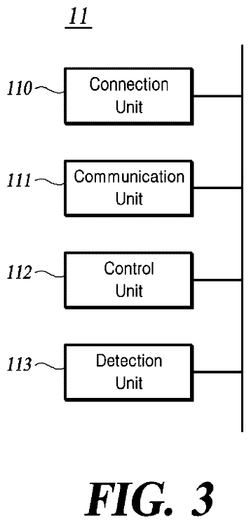

FIG. 3 is a schematic block diagram of the second controller 11 according to at least one embodiment of the present disclosure.

As shown in FIG. 3, the second controller 11 according to at least one embodiment may include all or some of a connection unit 110, a communication unit 111, a control unit 112, and a detection unit 113. Not all of the blocks illustrated in FIG. 3 are requisite components. In other embodiments, some of the blocks included in FIG. 3 may be added, changed, or deleted. Furthermore, the components illustrated in FIG. 3 represent functionally classified elements. At least one of the components may be implemented in a form that integrates in a real-world physical environment.

The connection unit 110 may have a plurality of wires connected to it. The connection unit 110 may be implemented by using a fuse. In this example, the fuse includes an electronic fuse. The second controller 11 may be connected via a wire connected with its connection unit 110 to the first controller 10. The second controller 11 may be connected via wires connected with its connection unit 110 to other second controllers.

The communication unit 111 may communicate with the other controllers by using various communication techniques, including controller area network (CAN) communication, e.g., ethernet, media oriented systems transport (MOST), Flexray, local interconnect network (LIN), and such automotive networks. The communication unit 111 may receive detection information from the other controllers. The communication unit 111 may transmit detection information to the other controllers. The detection information may include current magnitude and fault messages.

The control unit 112 controls the operation of the connection unit 110 to control paths for supplying power to the other second controllers. The control unit 112 may control the on-off operation of the fuse and thereby control the paths for supplying power to the other second controllers.

When the detection unit 113 detects a fault in a wire connected to any of the fuses included in the second controller 11, the control unit 112 turns off that fuse.

The detection unit 113 detects the condition of the wire connected to the connection unit 110 by detecting the magnitude of the current flowing in the wire. The detection unit 113 may determine whether a fault has occurred in the wires supplying power to the other second controllers by detecting the magnitude of the current. The detection unit 113 may determine that the wire connected to the second fuse is in a disconnected state if the magnitude of the current flowing in the wire is equal to or smaller than the first threshold. The detection unit 113 may determine that the wire connected to the second fuse is not disconnected if the magnitude of the current flowing in the wire is greater than the first threshold. The detection unit 113 may determine that the wire connected to the second fuse is in an overload condition if the magnitude of the current flowing in the wire is greater than or equal to the second threshold. The detection unit 113 may determine that the wire connected to the second fuse is not in an overload condition if the magnitude of the current flowing in the wire is smaller than the second threshold.

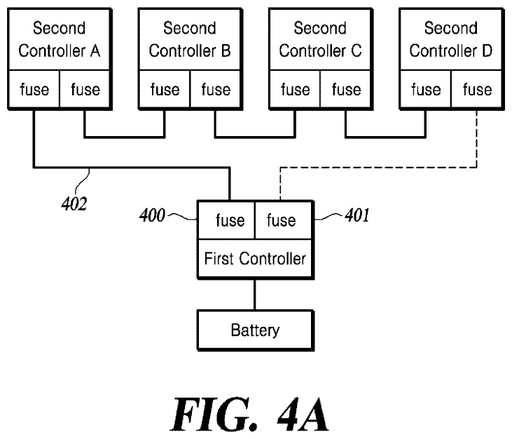

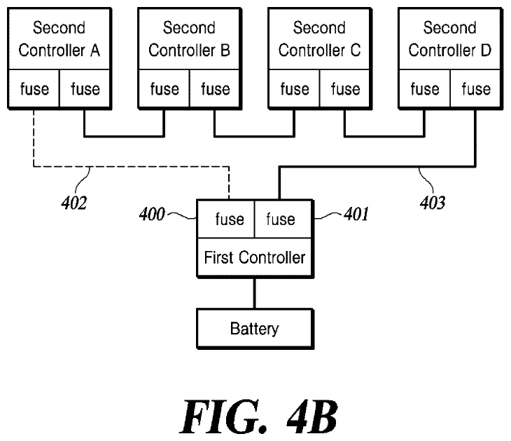

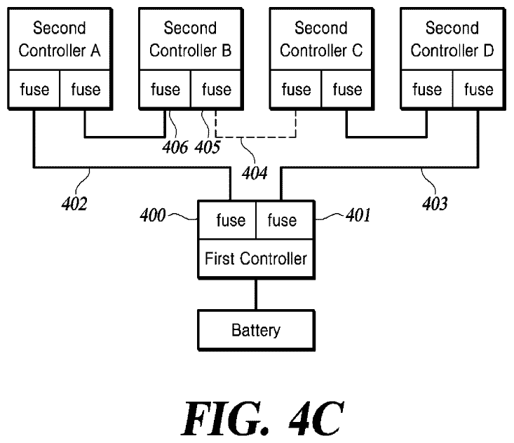

FIGS. 4A through 4C are diagrams illustrating the operation of a redundancy power grid system according to at least one embodiment of the present disclosure.

FIG. 4A illustrates a situation in which the wires connecting the controllers are not faulted and are normal. The redundancy power grid system has a first controller that receives power from a battery. The first controller has a main power fuse 400 that is powered on and a redundancy fuse 401 that is powered off. The first controller supplies power through a wire 402 connected with its main power fuse 400 to a second controller A. The second controller A supplies power to a second controller B which in turn supplies power to a second controller C which in turn supplies power to a second controller D. Thus, all controllers can be powered.

FIG. 4B shows a situation where the wire 402 connected with the main power fuse 400 of the first controller has a fault. The first controller receives power from the battery. The first controller may determine that a fault has occurred by detecting current flowing in the wire 402 connected with the main power fuse 400. The first controller turns off the main power fuse 400 to prevent power from being supplied to the second controller A through the wire 402 connected with the main power fuse 400. The first controller turns on the redundancy fuse 401 to supply power to the second controller D through a wire 403 connected with the redundancy fuse 401. The second controller D supplies power to the second controller C which in turn supplies power to the second controller B which in turn supplies power to the second controller A. Thus, all controllers can receive power. The first controller may provide fault information to the user indicating that a wire 402 connected with the main power fuse 400 has a fault.

FIG. 4C shows a situation where a wire 404 connecting the second controller B with the second controller C has a fault. The first controller receives power from the battery. The first controller supplies power through the wire 402 connected with the main power fuse 400 to the second controller A. The second controller A supplies power to the second controller B.

The second controller B may determine that a fault has occurred by detecting the current flowing in the wire 404 connected with the second fuse 405. The second controller B turns off its second fuse 405. The second controller B sends a fault message to the second controller A. The fault message includes the ID of the powering controller with a fault wire (ID of second controller B), the ID of the powered controller with a fault wire (ID of second controller C), and the fault information. The second controller B may transmit the fault message to the second controller A via a wire connected to its first fuse 406. The second controller A forwards the fault message to the first controller. Upon receiving the fault message, the first controller turns on the redundancy fuse 401. The first controller supplies power to the second controller D through the wire 403 connected with the redundancy fuse 401. The second controller D supplies power to the second controller C. Thus, all controllers can receive power. The first controller may provide fault information to the user that the wire 404 connecting second controller B with second controller C has a fault.

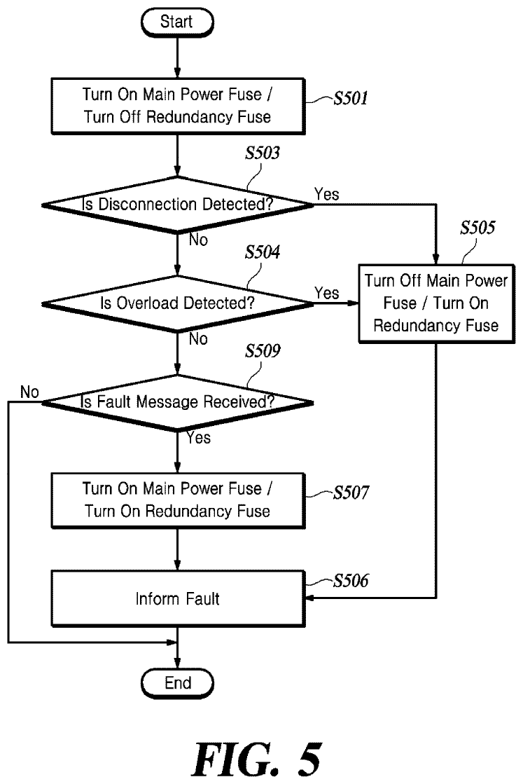

FIG. 5 is a flowchart of the operation of the first controller, according to at least one embodiment of the present disclosure.

The first controller includes a plurality of connected elements, such as the main power fuse and the redundancy fuse, and it receives power from a battery.

The main power fuse of the first controller is in an on state, and the redundancy fuse is in an off state (S501). The first controller supplies power to the second controller through a wire connected with the main power fuse.

The first controller determines whether the wire connected with the main power fuse is in a disconnected state (S503). The first controller detects the magnitude of current flowing in the wire connected with the main power fuse. If the magnitude of the current flowing in the wire connected with the main power fuse is equal to or smaller than a first threshold, the first controller determines that the wire is in a disconnected state.

When the first controller determines that the wire connected with the main power fuse is not disconnected, the first controller determines whether the wire connected with the main power fuse is in an overload condition (S504). The first controller detects the magnitude of the current flowing in the wire connected with the main power fuse. When the magnitude of the current flowing in the wire connected with the main power fuse is greater than or equal to the second threshold, the first controller determines that the wire is overloaded.

When the first controller determines that the wire connected with the main power fuse is disconnected or overloaded, the first controller turns off the main power fuse and turns on the redundancy fuse (S505). The first controller supplies power to the second controller through the wire connected with the redundancy fuse.

The first controller provides fault information to the user (S506). The fault information includes information that the wire connected with the main power fuse is disconnected or overloaded.

When the first controller determines that the wire connected with the main power fuse is not in a disconnected or overload condition and receives the fault message from the second controller, the first controller turns on the redundancy fuse (S507). For example, when the wire connected with the main power fuse is functioning normally, but the wire connected to the fuse on the second controller has a fault, the first controller determines that the wire connected with the main power fuse is not disconnected and overloaded and receives a fault message from the second controller. The first controller supplies power to the second controllers through the wire connected with the main power fuse and the wire connected with the redundancy fuse.

The first controller provides fault information to the user (S506). The fault information includes information that the wire connected to the second controller is disconnected or overloaded.

When the first controller determines that the wire connected with the main power fuse is not disconnected and overloaded and does not receive a fault message from the second controller, the first controller maintains the main power fuse on and the redundancy fuse off state (S509). The first controller supplies power to the second controller via the wire connected with the main power fuse.

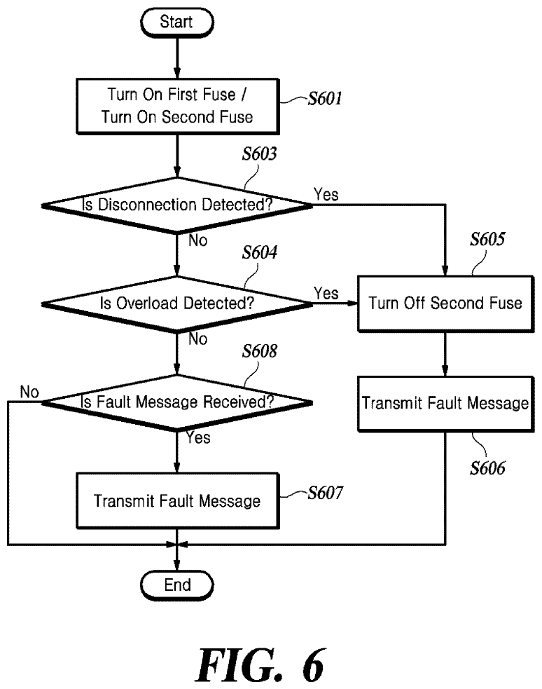

FIG. 6 is a flowchart of a method of operating the second controller, according to at least one of the present disclosure.

The second controller A, the second controller B, the second controller C, and the second controller X are distinguished to describe how the second controller operates and are not intended to limit the nature of the second controller. The second controller X may also be referred to as a second target controller.

The second controller X has a first fuse that is in an on state and a second fuse that is in an on state (S601). The second controller X receives power from the second controller A through a wire connected to the first fuse. When the second controller X is connected with the first controller through the wire connected to the first fuse, the second controller X receives power from the first controller. The second controller X supplies power to the second controller B through a wire connected to the second fuse. When the second controller X is connected with the first controller through the wire connected to the second fuse, the second controller X does not supply power to the first controller.

The second controller X determines whether the wire connected to the second fuse is disconnected (S603). The second controller X detects the magnitude of the current flowing in the wire connected to the second fuse. The second controller X determines that the wire connected to the second fuse is in a disconnected state if the magnitude of the current flowing in the wire is equal to or smaller than a first threshold.

If the second controller X determines that the wire connected to the second fuse is not disconnected, the second controller X determines whether the wire connected to the second fuse is in an overload condition (S604). The second controller X detects the magnitude of the current flowing in the wire connected to the second fuse. The second controller X determines that the wire connected to the second fuse is in an overload condition when the magnitude of the current flowing in the wire connected to the second fuse is greater than or equal to a second threshold.

When the second controller X determines that the wire connected to the second fuse is disconnected or overloaded, the second controller X turns off the second fuse (S605).

The second controller X sends a first fault message to the second controller A via the wire connected to the first fuse (S606). The fault message includes the ID of the powering controller with a fault wire (ID of second controller X), the ID of the powered controller with a fault wire (ID of second controller B), and fault information.

When the second controller X determines that the wire connected to the second fuse is neither disconnected nor overloaded and receives a second fault message from the second controller B, the second controller X sends the second fault message to the second controller A (S607). For example, when the wire connected to the second fuse is functioning normally, but the wire connected to the fuse of the second controller B is faulted, the second controller X determines that the wire connected to the second fuse is neither disconnected nor overloaded, and receives a fault message from the second controller B. The second controller X may send the second fault message to the second controller A through the wire connected to the first fuse. When second controller X is connected with the first controller via the wire connected to the first fuse, it sends the second fault message to the first controller.

When the first controller receives the first fault message, the first controller turns on the redundancy fuse. The second controller B, which was receiving power from the second controller X through the wire connected to the second fuse, receives power from the second controller C. When the second controller B is connected with the first controller through the wire connected to the second fuse, the second controller receives power from the first controller.

When the second controller X determines that the wire connected to the second fuse is not in a disconnected and overload condition, and has not received a fault message from the second controller B, the second controller X maintains the first fuse on state and the second fuse on state (S608). The second controller X receives power from the second controller A through the wire connected to the first fuse and supplies power to the second controller B through the wire connected to the second fuse. When the second controller X is connected with the first controller through the wire connected to the first fuse, the second controller X receives power from the first controller. When the second controller X is connected with the first controller through the wire connected to the second fuse, the second controller X does not supply power to the first controller.

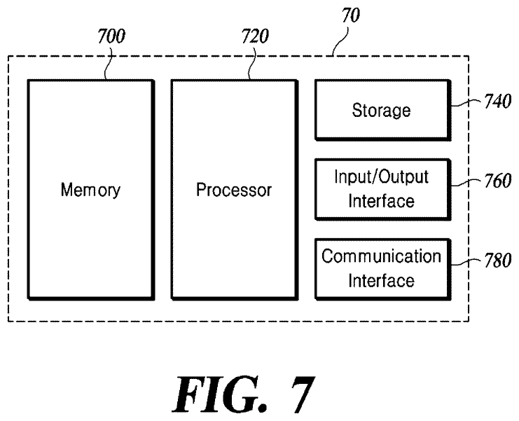

FIG. 7 is a schematic block diagram of an illustrative computing device that is applicable to the present disclosure.

Referring to FIG. 7, the computing device 70 may include some or all of a memory 700, a processor 720, a storage 740, an input/output interface 760, and a communication interface 780. The computing device 70 may structurally and/or functionally include some of the redundancy power grid system 1 illustrated in FIG. 1. The computing device 70 may be a stationary computing device, such as a desktop computer, server and/or intelligent camera, or the like, as well as a mobile computing device, such as smartphone and/or a laptop computer, or the like.

The memory 700 may store programs that cause the processor 720 to perform methods according to various embodiments of the present disclosure. For example, the program may include a plurality of computer-executable instructions executable by the processor 720. The plurality of computer-executable instructions may be executed by the processor 720 to perform the methods described above.

The memory 700 may be a single memory or a plurality of memories. The information required for image fusion may be stored in the single memory or may be stored divisively among the plurality of memories. When the memory 700 is composed of a plurality of memories, they may be physically separated. The memory 700 may include at least one of volatile memory and non-volatile memory. The volatile memory may include static random access memory (SRAM) or dynamic random access memory (DRAM), for example, and the non-volatile memory may include flash memory, for example.

The processor 720 may include at least one core capable of executing at least one set of computer-executable instructions. The processor 720 may execute the computer-executable instructions stored in the memory 700. The processor 720 may be a single processor or a plurality of processors.

The storage 740 maintains stored data even when power to the computing device 70 is interrupted. For example, the storage 740 may include non-volatile memory or may include a storage medium such as magnetic tape, optical disk, or magnetic disk.

Programs stored in the storage 740 may be loaded into the memory 700 before execution by the processor 720. The storage 740 may store files written in a program language and programs generated by a compiler or the like may be loaded from the files into the memory 700. The storage 740 may store data to be processed by the processor 720 and/or data that has been processed by the processor 720.

The input/output interface 760 may include an input device, such as a keyboard, mouse, touch interface, microphone, and/or camera, and may include an output device, such as a display and/or speakers. The input/output interface 760 allows the user to trigger the execution of the program by the processor 720, enter settings, and/or view the processing results of the program.

The communication interface 780 may provide access to an external network. The computing device 70 may communicate with a concerned party and other devices via the communication interface 780.

Each element of the apparatus or method can be implemented in hardware or software, or a combination of hardware and software. The functions of the respective elements may be implemented in software. A microprocessor can be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various implementations can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) may include instructions for a programmable processor and may be stored in a “computer-readable recording medium.”

A computer-readable recording medium includes any type of recording device that stores data that can be read by a computer system. Such a computer-readable recording medium may be a non-volatile or non-transitory medium, such as a ROM, CD-ROM, magnetic tape, floppy disk, memory card, hard disk, optical magnetic disk, or storage device, and may further include a transitory medium, such as a data transmission medium. The computer-readable recording medium may also be distributed across a networked computer system, such that the computer-readable code is stored and executed in a distributed manner.

Although operations are illustrated in the flowcharts/timing charts in this specification as being sequentially performed, this is merely a description of the technical idea of one embodiment of the present disclosure. In other words, those of ordinary skill in the art to which the present disclosure pertains may appreciate that various modifications and changes can be made without departing from essential features of embodiments of the present disclosure. In other words, the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those of ordinary skill in the art should appreciate that various modifications, additions, and substitutions are possible, without departing from the idea and scope of the claimed present disclosure. Therefore, various embodiments of the present disclosure have been described for the sake of brevity and clarity. The scope of the technical idea of the present disclosure is not limited by the illustrations. Accordingly, one of ordinary skill in the art would understand that the scope of the claimed present disclosure is not to be limited by the above explicitly described embodiments but by the claims and equivalents thereof.

REFERENCE NUMERALS

| | |
|---|---|
| 1: redundancy power grid system | 10: first controller |
| 11: second controller | 12: multiple second controllers |
| 400: main power fuse | 401: redundancy fuse |

What is claimed is:

1. A redundancy power grid system, comprising:
a battery;
a first controller including a main power fuse and a redundancy fuse; and
multiple second controllers each including a first fuse and a second fuse,
wherein the first controller is connected with the battery,
wherein the second controllers are connected in series via a wire connected to the first fuse and a wire connected to the second fuse, and
wherein the second controllers have two opposite-end second controllers that are connected to the first controller via a wire connected with the main power fuse and a wire connected with the redundancy fuse, respectively.

2. The redundancy power grid system of claim 1, wherein the first controller is configured to turn on the main power fuse and turn off the redundancy fuse when the wire connected with the main power fuse is in normal operation, and the second controllers each turn on the first fuse and the second fuse.

3. The redundancy power grid system of claim 2, wherein the first controller is configured to detect a magnitude of current flowing in the wire connected with the main power fuse.

4. The redundancy power grid system of claim 3, wherein the first controller is configured to:
determine that the wire connected with the main power fuse is disconnected if the magnitude of the current flowing in the wire connected with the main power fuse is equal to or smaller than a first threshold; and
determine that the wire connected with the main power fuse is in an overload condition if the magnitude of the current flowing in the wire connected with the main power fuse is equal to or greater than a second threshold.

5. The redundancy power grid system of claim 4, wherein the first controller is configured to turn off the main power fuse and turn on the redundancy fuse when the first controller determines that the wire connected with the main power fuse is in a disconnected or overload condition.

6. The redundancy power grid system of claim 5, wherein the first controller is configured to provide a user with an indication that the wire connected with the main power fuse is in the disconnected or overload condition.

7. The redundancy power grid system of claim 2, wherein the second controllers are each configured to detect a magnitude of current flowing in the wire connected to the second fuse.

8. The redundancy power grid system of claim 7, wherein the second controller is configured to:
determine that the wire connected to the second fuse is disconnected if the magnitude of the current flowing in the wire connected to the second fuse is equal to or smaller than a first threshold; and
determine that the wire connected to the second fuse is in an overload condition if the magnitude of the current flowing in the wire connected to the second fuse is equal to or greater than a second threshold.

9. The redundancy power grid system of claim 8, wherein a second target controller from among the second controllers is configured to turn off the second fuse included in the second target controller when the second target controller determines that a wire connected to the second fuse included in the second target controller is in a disconnected or overload condition.

10. The redundancy power grid system of claim 9,
wherein, the second target controller is configured to transmit a fault message via a wire connected to the first fuse included in the second target controller; and
wherein, the fault message includes an ID of a fault detection controller, an ID of a fault controller, and fault information.

11. The redundancy power grid system of claim 10, wherein the first controller is configured to turn on the redundancy fuse when the first controller receives the fault message.

12. The redundancy power grid system of claim 11, wherein the first controller is configured to provide a user with an indication that the wire connected to the second fuse included in the second target controller is in a disconnected or overload condition.

13. A method of operating a redundancy power grid system including a battery, a first controller including a main power fuse and a redundancy fuse, and multiple second controllers, wherein each second controller includes a first fuse and a second fuse, the first controller being connected with the battery, the second controllers being connected in series via a wire connected to the first fuse and a wire connected to the second fuse, and the second controllers having two opposite-end second controllers that are connected to the first controller via a wire connected with the main power fuse and a wire connected with the redundancy fuse, respectively, the method comprising:
causing the first controller to control on-off operations of the main power fuse and the redundancy fuse; and
causing the second controllers to control on-off operations of the first fuse and the second fuse.
